(19) United States
(12) Patent Application Publication
(10) Pub. No.: US 2014/0064694 A1
(43) Pub. Date: Mar. 6, 2014

(54) MULTIMEDIA CONTENT CARD

(71) Applicant: Carl Zealer, Canal Winchester, OH (US)

(72) Inventor: Carl Zealer, Canal Winchester, OH (US)

(21) Appl. No.: 13/974,192

(22) Filed: Aug. 23, 2013

Related U.S. Application Data
(60) Provisional application No. 61/694,023, filed on Aug. 28, 2012.

(51) Int. Cl. H04N 5/76

(52) U.S. Cl. CPC H04N 5/76
USPC 386/230

(57) ABSTRACT

One or more systems or methods for providing a multimedia content card are provided. A multimedia content card can display one or more portions of multimedia content. In one or more embodiments, the multimedia content card can be used as a business card or loaded with contact information, other pertinent data, or applications, for example. The multimedia content card can be configured to direct one or more behaviors for one or more devices. A development interface can be provided to design one or more functional features or one or more aesthetic features of the multimedia content card. The multimedia content card can be configured to display business content, professional networking content, product details, offers, promotions, sports content, greetings, invitations, etc. In this way, a multimedia content card may be provided with a versatile range of utilities or applications, for example.

### CROSS-REFERENCE TO RELATED APPLICATIONS

This application claims the benefit of U.S. Provisional Patent Application Ser. No. 61/694,023 (Attorney Docket No. 104542.19PRO) entitled “MULTIMEDIA CONTENT CARD”, filed on Aug. 28, 2012. The entirety of the above-noted application is incorporated by reference herein.

### BACKGROUND

Organizations of all kinds are constantly seeking new ways to leverage technology to complement traditional interpersonal networking, marketing, and communication. Web-hosted multimedia content is wildly popular, as shown by the success of various streaming services. Similarly, social networking propelled the internet presence of many organizations from a formal, external-facing website to an interactive, entertaining means to engage with outside entities.

Nonetheless, content that is exclusively internet-based may have several drawbacks. Notably, it requires that a person remembers to actively locate, load, and view the content online. Often, internet-based multimedia content lacks the means to remind a viewer to act or revisit at a later time, and many services that do offer e-mail or text reminders quickly find their messages ignored or contact lists unsubscribed. More specific means of electronic communication exist, (e.g., vCards, electronic calendar appointments, and cellular-phone based instant messaging), but these techniques often lack interoperability depending on different users' devices and operating systems, available software suites, and level of technical proficiency.

This increased reliance on web-based multimedia content has been driven by improved portability and affordability of computerized devices. To date, individuals and organizations have failed to exploit this hardware availability, instead relying upon devices owned and operated by external entities. Additionally, traditional means of communication and business such as business cards, credit and loyalty cards, mailings, and pamphlets have generally lacked modernization to keep pace with current technologies.

### SUMMARY

This summary is provided to introduce a selection of concepts in a simplified form that are described below in the detailed description. This summary is not intended to be an extensive overview of the claimed subject matter, identify key factors or essential features of the claimed subject matter, nor is it intended to be used to limit the scope of the claimed subject matter.

One or more systems or methods of providing a multimedia content card are disclosed herein. The system can include a display component and a content control component. One or more components of the system can be embedded within a card housing which may be about the size of a business card, trading card, credit card, etc. The display component can be configured to render one or more portions of multimedia content provided by the content control component. The content control component can be operatively coupled with an interface component that can be configured to trigger rendering of one or more portions of the multimedia content. The multimedia content card can include external communication or a communication port, including wired communication, such as USB or wireless communication such as Wi-Fi, Bluetooth, infrared, etc., and can receive power from a wired power source, via a wireless power source, via solar cells, etc., for example.

The multimedia content card can be used as a business card, and be configured to present one or more portions of content or multimedia content to a user. For example, the multimedia content card can be configured to display an email address, a name, an address, a picture or head shot of an individual, a social media hyperlink, a professional networking hyperlink, etc. The multimedia content card can be used to promote products by presenting multimedia content related to or associated with a product. Additionally, the multimedia content card can be used as a greeting card, such as for a birthday, an anniversary, an invitation, etc. In other embodiments, the multimedia content card can be a collectible that displays multimedia content associated with a theme, such as a sport (e.g., baseball, football, basketball, soccer, or other activities), a player, a team, etc.

According to one or more aspects, a pointer component may be configured to cause a behavior on one or more devices with which the multimedia content card interacts. As an example, a multimedia content card can connect, via a wired connection or wirelessly, to a user's phone. Upon establishing communication with the phone, the multimedia content card can automatically run an instruction on the phone, or direct an application resident on the phone to nonlocal content.

In one or more embodiments, a user can employ a development interface system to design functional and aesthetic features of a multimedia content card. For example, a user can operate a computer program to submit multimedia content for inclusion on multimedia content cards. Based on the user's submission, one or more multimedia content cards can be created containing the user's multimedia content.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example multimedia content card system, according to one or more embodiments.

FIG. 2 is an illustration of an example multimedia content card system, according to one or more embodiments.

FIG. 3A is an illustration of an example multimedia content card system, according to one or more embodiments.

FIG. 3B is an illustration of an example multimedia content card system, according to one or more embodiments.

FIG. 4 is an illustration of an example multimedia content card design system, according to one or more embodiments.

FIG. 5 is an illustration of an example flow diagram of a method for presenting multimedia content, according to one or more embodiments.

FIG. 6 is an illustration of an example flow diagram of a method for presenting multimedia content, according to one or more embodiments.

FIG. 7 is an illustration of an example computer-readable medium or computer-readable device including processor-executable instructions configured to embody one or more of the provisions set forth herein, according to one or more embodiments.

FIG. 8 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

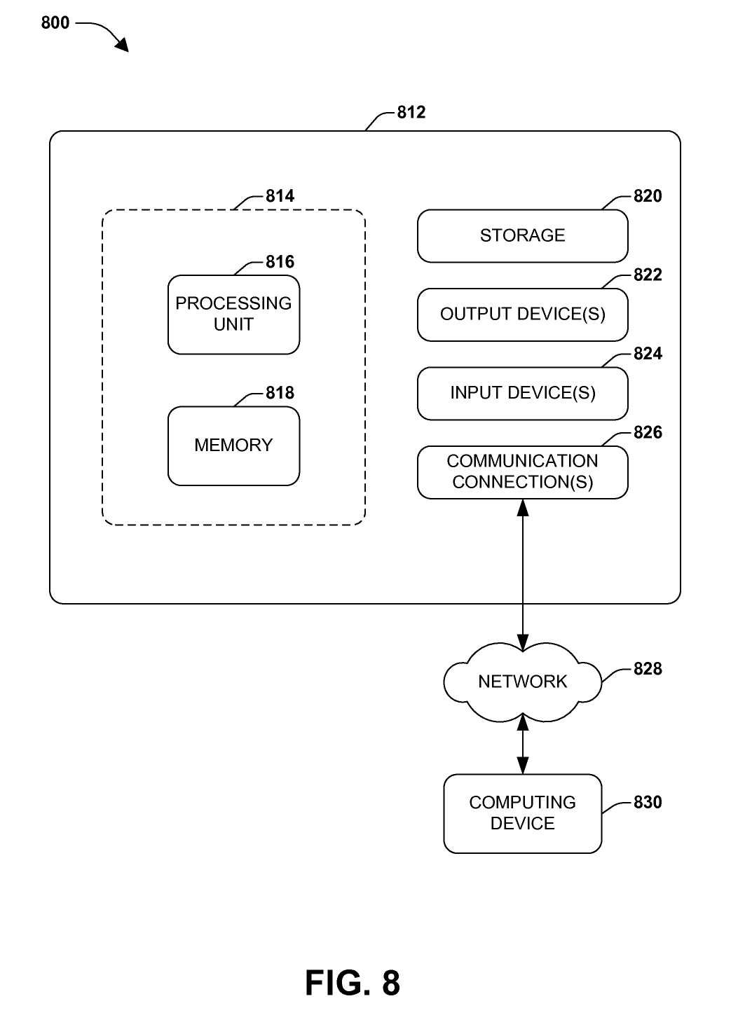

For one or more of the figures herein, one or more boundaries, such as boundary 814 of FIG. 8, for example, are drawn with different heights, widths, perimeters, aspect ratios, shapes, etc. relative to one another merely for illustrative purposes, and are not necessarily drawn to scale. For example, because dashed or dotted lines are used to represent different boundaries, if the dashed and dotted lines were drawn on top of one another they would not be distinguishable in the figures, and thus are drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but can encompass a portion of one or more other components as well.

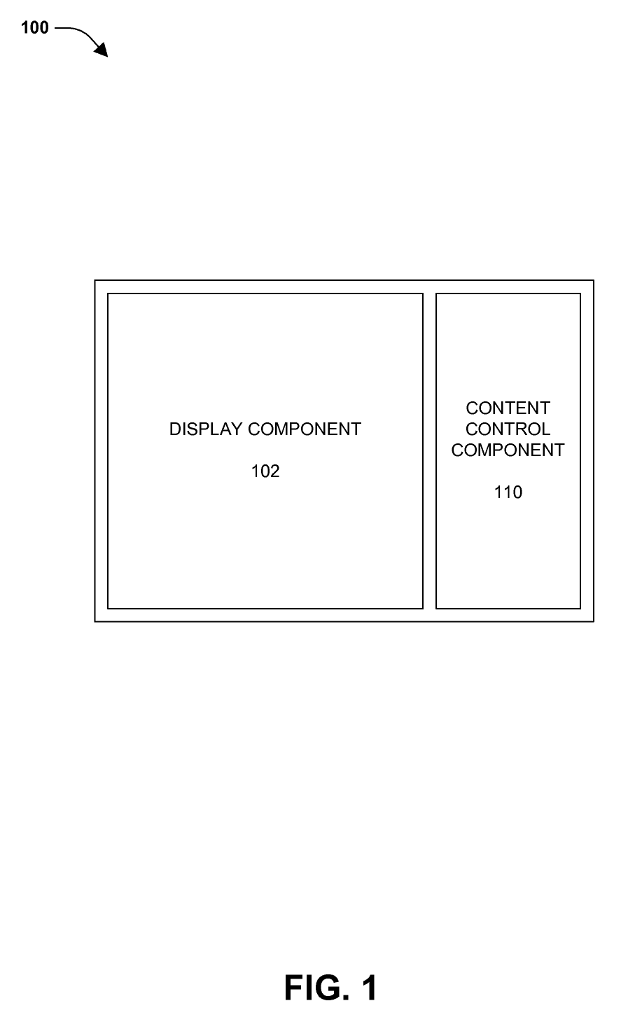

FIG. 1 is an illustration of an example multimedia content card system 100, according to one or more embodiments. In one or more embodiments, the multimedia content card system 100 can be highly compact or compact. For example, the multimedia content card system 100 can be about the size of a business card or a credit card, and can fit in compartments storing similarly-sized items, such as a slot of a wallet. While one or more ‘business card’ analogies may be referred to herein, the systems or methods disclosed are not limited to embodiments reflecting the size, shape, content or other features of a business card. Further, examples or drawings illustrating such comparisons are merely for purposes of convenience and concision. In one or more embodiments, the multimedia content card system 100 or one or more components thereof can be constructed using flexible components or flexible materials, allowing the multimedia content card system 100 to be bent, rolled, or otherwise deformed without damage to the function of the multimedia content card system 100. For example, the display component 102 can be made of a flexible material.

In one or more embodiments, the multimedia content card system 100 can include a display component 102 and a content control component 110. The display component 102 can include one or more screens utilizing liquid crystal display (LCD) technology (e.g., color super twisted nematic, thin film transistor, thin film diode), light emitting diode (LED) technology (e.g., traditional LED, passive matrix organic LED, active matrix organic LED), plasma, electroluminescent panel, or other technologies utilized in rendering imagery. In one or more embodiments, the display component 102 can include a monochrome display with alphanumeric features, graphic features, or a combination thereof. In other embodiments, the display component 102 can include touchscreen technology, including capacitive touchscreens, resistive touchscreens, or a combination thereof. In one or more embodiments, the display component 102 can utilize a combination of multiple display technologies set forth herein.

Additionally, the display component 102 can be configured to display or render one or more portions of multimedia content. Multimedia content can include text, images, animations, video, data streams, audio, reactive content, interactive content, etc. In one or more embodiments, multimedia content can include reactive content or interactive content that may be triggered, altered, or changed by one or more inputs. In other words a user or recipient of the multimedia content card system 100 of FIG. 1 can interact with interactive content displayed on the display component 102. For example, inputs can be active (e.g., a user action, an instruction, pressing a button, making a selection, entering text, speaking an audible instruction), passive (e.g., change in observable light, sensed small or geographic motion, sounds, detection of chemicals or materials, presence of magnetic or electrical fields, contact with other networks or energies), or combinations thereof.

The content control component 110 can be configured to determine one or more portions of multimedia content to be rendered or displayed. The content control component 110 can be configured to present or transmit one or more portions of the multimedia content to the display component 102. In one or more embodiments, the content control component 110 can have access to one or more portions of multimedia content. For example multimedia content can include an email address, a hyperlink (e.g., a hyperlink to a social media account profile, etc.), personal greeting, marketing video, series of electronic business cards, slideshow, fixed or scrolling text, instructive animation, static website-type display, or other visual content. In one or more embodiments, one or more portions of multimedia content can be information found in trading cards or other collectable items.

In other embodiments, the content control component 110 has access to a plurality of multimedia content that may be presented or displayed on the display component 102. The content control component 110 can be configured to present one or more portions of multimedia content in a fixed, random, or predetermined order or format, etc. For example, the multimedia content card system 100 can play a portion of multimedia content once or repeat one or more portions, alone or concurrently. Further, the display component 102 can be configured to split the display into one or more areas, layer one or more portions of the multimedia content with one or more other portions of the multimedia content, etc. In other words, the multimedia content card system 100 can be configured to display one or more portions of the multimedia content in a variety of orders or formats.

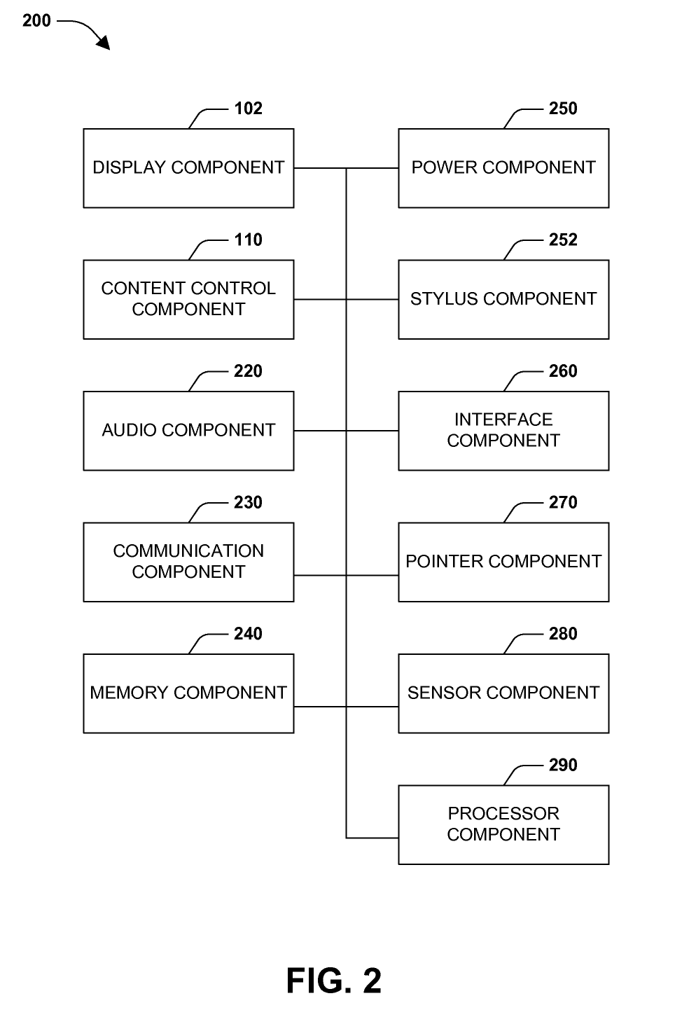

FIG. 2 is an illustration of an example multimedia content card system 200, according to one or more embodiments. In one or more embodiments, the multimedia content card system 200 or multimedia content card 200 can include a display component 102, a content control component 110, an audio component 220, a communication component 230, a memory component 240, a power component 250, a stylus component 252, an interface component 260, a pointer component 270, a sensor component 280, or a processor component 290. Additionally, one or more of these components can be encased or embedded in a card housing (not shown in FIG. 2), which may be a flexible or rigid housing that protects one or more of these components. It will be appreciated that one or more components may be combined, have similar functionalities, or omitted according to one or more aspects. In other words, one or more components may exist, functionally, literally, etc. within other components or merely receive inputs from other components, or provide outputs to other components. Similarly, additional components may be utilized in one or more embodiments.

The display component 102 can be configured to render or display one or more portions of multimedia content. The multimedia content can include text, images, animations, video, data streams, audio, reactive content, interactive content, etc. As an example, interactive content can be triggered, altered, or changed based on one or more inputs (e.g., touch screen inputs if the display component 102 is a touch screen, inputs from an interface component 260, such as a button, etc.). Additionally, the display component 102 can be embedded within a card housing (not shown), such that the system or the multimedia content card system 200 has a similar size, shape, attributes, characteristics, etc. to a credit card or business card, for example. In other words, one or more components of the multimedia content card system 200 may be flexible such that the multimedia content card system 200 may be bent, rolled, or deformed while maintaining functionality.

The content control component 110 can be configured to monitor, manage, or trigger rendering of one or more portions of multimedia content associated with the multimedia content card system 200 of FIG. 2. That is, the display component 102 can be configured to display one or more portions of the multimedia content as directed by or presented from the content control component 110. For example, a memory component 240 or a storage component of the multimedia content card system 200 may have content or multimedia content stored thereon. In some scenarios, the display component 102 may not be able to display all of the content stored on the memory component 240 in a concurrent fashion (e.g., because the display component may not have enough ‘real estate’). In these scenarios, the content control component 110 may be configured to render or display one or more portions of content according to one or more display modes or one or more display screens.

For example, a display mode or display screen can have one or more portions of preprogrammed content or multimedia content organized so that a user or recipient of a multimedia content card can cycle through one or more of the display modes or one or more of the display screens. Explained another way, when a user presses a button on the multimedia content card, such as the interface component 260, one or more different portions of content may be rendered. In one or more embodiments, the content control component 110 can be configured to render contact information on the display component 102. When a user presses a button on the multimedia content card system 200, the content control component 110 may cause the display component 102 to render a logo (e.g., an animated logo). If the button is pressed a second time, the content control component 110 may cycle back to the originally rendered contact information or to another screen, such as a biography or credentials, for example. In this way, the content control component 110 can be configured to enable a user, viewer, or recipient, etc. to view a variety of information, content, or multimedia content, thereby providing one or more portions of multimedia content.

In one or more embodiments, the content control component 110 can be configured to determine one or more functions, behaviors, or conditions associated with the interface component 260. In other words, the content control component 110 can adjust how a button of the multimedia content card system 200 affects operation thereof. For example, in one or more embodiments, the content control component 110 can program the interface component 260 to illuminate a backlight for the display component 102.

Additionally, the content control component 110 can be configured to handle or manage content associated with the multimedia content card system 200. For example, the content control component 110 can enable a user to upload or download content or multimedia content to or from one or more devices or external devices, such as a computer, a tablet, a mobile phone, etc. A device can connect to the multimedia content card system 200 via the communication component 230. In one or more embodiments, the communication component includes or has a communication port that facilitates or enables data to be transmitted or received. For example, when a mobile phone is plugged into the multimedia content card system 200, contact information, such as a phone number can automatically be downloaded to the mobile phone. Similarly, when a tablet or computer is connected to the multimedia content card system 200, the content control component 110 can determine one or more suitable or compatible applications, and update one or more of the respective applications accordingly. For example, if the computer has an email application installed, the content control component 110 can detect the email application upon connection, and import email contact information or other information into the email application. In this way, the content control component 110 can be configured to import content or data (e.g., download content or data from a multimedia content card) from the multimedia content card system 200 to one or more devices based on a type of device connected to the multimedia content card system 200.

In one or more embodiments, the content control component 110 can be configured to detect one or more accounts, one or more applications, one or more mirrored content, etc. from a recipient. That is, upon connection to a device of a recipient, the content control component 110 can determine one or more applications that the recipient has installed on that device, and update or provide corresponding contact information accordingly. For example, if the recipient has an email application and a social networking application installed on his or her device, the content control component 110 may import an email to the email application from the multimedia content card system 200 and initiate a ‘friend request’ or social media connection between the recipient and a user associated with the multimedia content card system 200.

For example, when the multimedia content card system 200 (e.g., associated with content or social media content from a first entity) is plugged into a device (e.g., associated with, owned, or used by a second entity) with a social media application installed, the system 200 can initiate or transmit a social media request, social media friend request, contact request, etc. from the device of the second entity to the first entity, such as over a network, etc. In other words, when the system 200 (e.g., business card of the first entity) is plugged into a device or mobile phone of a second entity, the system 200 can initiate a friend request from the mobile device of the second entity to the first entity. In this way, the system 200 can act as a ‘physical’ version of a contact request or friend request, for example.

As another example, if a recipient has a social media account and an email, but does not use facsimile, a hyperlink to the social media account and an email address may be displayed or imported, while a facsimile number associated with the multimedia content card system 200 may not be presented or imported to the recipient or the device of the recipient.

Similarly, the content control component 110 can be configured to upload content to a multimedia content card system 200. For example, a user distributing the multimedia content card 200 may desire to update or provide additional information, content, or multimedia content. The content control component 110 may have an input mode that enables a user to input information into the multimedia content card system 200. For example, when a keyboard (e.g., having a USB connection) is connected to a communication port or the communication component 230, the content control component 110 may automatically enter input mode, thereby enabling a user to input text content. In one or more embodiments, when a device is connected, the content control component 110 may provide a user with an option to enter input mode. In this way, the content control component 110 enables upload of content or multimedia content to the multimedia content card system 200. In other embodiments, input mode may be disabled after initial programming or distribution of the multimedia content card system 200, thereby disabling upload of content to the multimedia content card system 200 after a distribution time. This enables a designer, user, or distributor of the system 200 to make the system or card reusable or non-reusable.

If the system 200 is being used as a business card, contacts can be imported when the system 200 is connected to a device via a communication port or communication component 230. The system 200 or multimedia content card 200 can be associated with (e.g., store in memory) a variety of information or content. The content control component 110 can be configured to auto launch one or more applications to facilitate communication, such as a phone application dialing a phone number associated with the system 200. Similarly, the content control component 110 can launch an email application with an email composed to an email address associated with the system 200. The content control component 110 may access one or more networks, social networks, contact lists, etc. via the communication component 230. By doing so, the content control component 110 can be configured to suggest one or more contacts, determine one or more degrees of separation between a recipient and one or more other individuals, such as suggested contacts, for example. As an example, the content control component 110 can compare a contact list associated with the system 200 and a contact list of the recipient (e.g., or email lists, friend lists, etc.).

Further, the content control component 110 can be configured to customize one or more aspects of the multimedia content card system 200 to one or more users or one or more recipients. As an example, the content control component 110 may be configured to manage formatting of one or more portions of multimedia content to be displayed by the display component 102. This means that the content control component 110 may automatically format one or more portions of content based on a screen size, preprogrammed defaults, or other characteristics or attributes, etc. of the multimedia content card system 200. In one or more embodiments, the content control component 110 can be a menu that enables a user, recipient, or designer to select content to be displayed. For example, if the display component 102 is configured to display two lines of information or content, the content control component 110 may select name and email as defaults to be displayed, etc.

In one or more embodiments, the content control component 110 can be configured to manage one or more aspects associated with one or more portions of content associated with the multimedia content card system 200. For example, the content control component 110 may manage a temporal aspect of content, such as expiration of content. In other embodiments, the content control component 110 can be configured to execute one or more instructions, commands, applications, prompts, etc. based on a connection to a device, a type of device connected, applications detected on a connected device, etc.

The interface component 260 can provide one or more interfaces (e.g. buttons, etc.) to an individual in possession (e.g., user, recipient, designer, etc.) of the multimedia content card system 200. The interface component 260 can be configured to cause one or more actions on one or more devices, one or more external electronic devices, or the multimedia content card system 200 itself (e.g., switching between one or more display modes or an input mode, etc.). The interface component 260 can be an on/off switch in one or more embodiments, or configured to illuminate a backlight for the display component 102, among other things. In this way, the interface component 260 can cause rendering of one or more portions of content, enable or disable one or more features of the multimedia content card system 200, etc. In one or more embodiments, the interface component 260 can be integrated with or include one or more sensors, such as the sensor component 280.

In one or more embodiments, the interface component 260 can be a button that, when pressed, provides an input for the content control component 110 to play one or more portions of content or multimedia content. In other embodiments, the interface component 260 can be combined with the display component 102 as a touchscreen display. In such embodiments, a button can be represented virtually or be pressed on the touchscreen, either by hand or with a stylus component 252. One or more buttons can be presented, either as individual selections linked to an action, or representing selection or radio fields, check boxes, drop down menus, maps or trees, input boxes, dials, sliders, etc. In one or more embodiments, the interface component 260 can be represented on a touchscreen or elsewhere including more complex features such as a virtual keypad or virtual keyboard. The interface component 260 can include one or more controls relating to portions of multimedia content. As an example, controls can include buttons permitting a user to play, pause, rewind, fast-forward, skip, and so forth. Mute and volume controls can be included with the interface component 260 or the audio component 220.

The audio component 220 can include one or more speakers, one or more microphones, or a combination thereof. Audio component 220 can be used to provide audio associated with displayable portions of multimedia content. Audio can be played back in sync with, out of sync with, or without displayable content presented on the display component 102. The audio component 220 can also monitor one or more microphones, continuously or pursuant to input, for interaction or other purposes coincident with the capabilities of aspects described herein.

The communication component 230 can be configured to enable connectivity from the multimedia content card system 200 to one or more devices, such as by communicating with one or more devices or one or more external electronic devices over a network, for example. In other words, the communication component 230 can establish communication between the multimedia content card system 200 and one or more devices, such as by transmitting or receiving content, data, information, instructions, commands, etc. between one or more of the devices and the system 200. As an example, an instruction or command can execute a program or application, launch a web page, open multimedia content, install an application or an update, import data, export data, etc.

Communication component 230 can include wired or wireless ports to contact other devices outside of the system 200. In one or more embodiments, communication component 230 can include a USB port, mini-USB port, micro-USB port, or combinations thereof, to facilitate connectivity with devices, external electronics such as desktop computers, notebook computers, cellular telephones, tablet devices, etc. In one or more embodiments, the USB port(s) can be male or female. For example, a male USB connector can be mechanically configured to retract, fold, collapse or otherwise change its orientation to hide within the primary contours of the housing of system 200 in a fashion that enables the male USB connector to extend for connection to a female USB port, and withdraw when not in use to conform to the aesthetics and portability of system 200. Communication component 230 can, in one or more embodiments, include communication ports in addition to or in place of USB port(s). Communication component 230 can include ports for memory cards (e.g., MS/SD/MMC), audio (e.g., microphones, headphones, speakers), PS/2 connectors, DVI, HDMI, VGA, coaxial cables, serial data, Ethernet (e.g. category 5 cable or crossover cable), telephone line, or other ports in use in modern computers. Communication component 230 can also include, non-exclusively, wireless ports such as ports supporting Wi-Fi, infrared, Bluetooth®, or other radio or wireless communication means used in modern electronic devices. Where communication component 230 establishes network connectivity, communication component 230 can function in intranet or internet settings.

In one or more embodiments, the pointer component 270 can be configured to cause one or more behaviors on one or more devices coupled to the multimedia content card, such as via the interface component 260. Pointer component 270 can cause a device or an external device to execute a behavior upon contact from system 200. For example, pointer component 270 can include an “auto run” file that executes a program when system 200 is mounted to a device, such as a computer or telephone. In one or more embodiments, pointer component 270 can cause an external device to launch a web browser and direct the browser to one or more websites. In another embodiment, pointer component 270 launches or installs a new program on an external device. Adaptations of these or other schemes can include launching a website or program along with documentation or instructions, executing a media viewer program to play a portion of multimedia content from system 200 on another device, directing a user to an update system, etc. Many variations of this practice can be understood to those skilled in the art, and accordingly the details set forth in this paragraph are recognized only to set forth examples demonstrating the essence of the pointer component, rather than any sort of exhaustive list of possibilities.

Sensor component 280 can detect one or more inputs in one or more embodiments. Sensor component 280 can include global positioning systems, local positioning systems (e.g. employing triangulation), timers, clocks, optical or mechanical motion detectors, microphones, thermometers or other environmental sensors, chemical sensors, light sensors, cameras, etc. Sensor component 280 can provide input to interface component 260 or content control component 110 to actuate or alter one or more portions of multimedia content based on one or more sensed or environmental factors.

Memory component 240 (e.g. or storage component) can store one or more portions of multimedia content or means for presenting one or more portions of multimedia content using display component 102 or audio component 220. In one or more embodiments, memory component 240 can store additional features or applications, such as alternative media viewers, camera software, statistics aggregators, web browsing programs, music players, etc. In one or more embodiments, memory component 240 interacts with communication component 230 to receive additional or other data. Such additional or alternative data can include updates to stored software or newer portions of multimedia content (e.g., updated contact information for multimedia business card, new product videos, seasonal greeting, statistics, or news related to an entity associated with the multimedia content). In one or more embodiments, memory component 240 can include random access memory, read only memory, magnetic storage, flash or other solid state storage, etc.

The processor component 290 can process data associated with the system 200 (e.g. stored on the memory component 240) or accessible via communication component 230. The processor component 290 can facilitate content control or operations of the content control component 110.

The power component 250 can provide a power source for system 200. In one or more embodiments, power component 250 can be a battery. The power component 250 can operate with, exist within, or contain communication component 230 where technologies enable recharging via a communication port. For example, power component 250 can operate with communication component 230 to access a USB port to recharge an internal battery. In another embodiment, power component 250 can utilize wireless power transfer means to recharge an internal battery.

In one or more embodiments, while system 200 may be employed as a multimedia business card, the presence of useful applications in memory component 240 or a digital camera in sensor component 280 can provide the user with benefits beyond those associated with a business card. Various specific sensors or applications could also have a wide range of uses in industrial (e.g. hazardous chemical sensor), business (e.g. calculator) or home settings (e.g. cooking timer), giving specific benefits to particular groups of users. By providing additional functionality, a person given the multimedia business card may be more likely to retain and repeatedly use the system 200, providing ongoing value to the individual or business that distributed the business card. In an example, a web browsing application on board of the system 200 can be branded to the business that issued or distributed the business card. In another example, photos taken with the business card can include a watermark for the business. In one or more embodiments, when the card is connected to a network or other device, the card can update business information or download newer marketing material.

While details supra and infra focus at times on the analogy of a business card including dynamic multimedia capabilities, those skilled in the art will appreciate the flexibility of this system with regard to other card-type applications. For example, as described above, the multimedia card can include content typically associated with trading cards or other collectibles. In one or more embodiments, a multimedia content card can be implemented as a collectible card or a baseball card including dynamic content.

In this example, the display component 102 can include one or more displays on the front or back of the card, and can display information typically associated with a baseball card, such as, for example, a pitcher's wins, losses, saves, earned run average (ERA), etc. One or more pictures or images of a player can be provided, as with a traditional baseball card. However, unlike a traditional paper baseball card, the multimedia content card is not limited in terms of card “real estate” or the information available upon printing of the card. Accordingly, a baseball card in accordance with details set forth herein can include additional statistics not typically captured on a baseball card, such as batting average on balls in play, fielder-independent pitching, and home run rate. Additionally, the card can be updated throughout the season to provide real-time stats, rather than rendering the card obsolete as only reflecting previous years. For example, when the card is connected to a computer or a device with an internet connection, the content control component 110 may be configured to search one or more databases to update content (e.g., stored on the memory component 240) associated with the card accordingly.

Given the flexibility of the multimedia content card, its use can be extended to make a baseball card not only reflect a player card, but capture multiple baseball cards in a device. For example, an entire team can be reflected on a card, allowing a user to scroll through or select one or more players from a roster. In one or more embodiments, the user can add or drop players from a customized roster on a multi-player baseball card-type multimedia card. In one or more embodiments, the card can be designed to allow reflection of or sync with a user's “fantasy” baseball team. In one or more embodiments, the user can manage a fantasy team via a multimedia content card.

In addition, such a baseball card can include, either in local storage or via a network, a sponsor website or application that allows a user to access information regarding the card's sponsor (that may or may not be related to a particular player or team), the player(s) associated with the card, the team(s) associated with the card, and so forth. In one or more embodiments, pointer component 270 enables this aspect, and can direct a card user to one or more websites or other media associated with content on the card.

In one or more embodiments, a baseball card-type multimedia card can display video via display component 102. In one or more embodiments, the card displays stored video, such as videos of career or season highlights associated with a baseball player. These videos can be updated throughout a season. In embodiments, video can be streamed to the card, allowing a user to watch a baseball game on the card, either live or by playing back a recorded game.

While one or more embodiments above related to trading cards or collectable cards have been described as baseball cards, it will be appreciated that any type of collectable or statistic-bearing card can be accomplished in the same fashion. While baseball is described to facilitate a level of detail, it will be appreciated that the application could just as easily be used to describe trading cards, collectables, or other products related to football, basketball, hockey, soccer, motor sports, combat sports, golf, etc. In addition, similar embodiments within the scope of the disclosure need not be confined to sports, as such collectables can also be related to television shows or movies, books or comics, celebrities, non-athletic games (e.g. video games, board games, card-based games, role-playing games), etc. In other non-limiting embodiments, a multimedia content card can be used in conjunction with other collectables, such as providing details relating to coin collections, stamp collections, etc.

In one or more embodiments, the system 200 can be configured to house content such as greeting card or e-card content. For example, the memory component 240 may be configured to house content associated with a greeting, congratulatory statements, birthdays, anniversaries, invitations (e.g., when plugged in a web page associated with the event could be launched), etc. In one or more embodiments, one or more portions of multimedia content may be associated with a gift having monetary value. A recipient of the multimedia content card system 200 could receive or redeem the gift by connecting the multimedia content card system 200 to a device, such as a computer or tablet, for example. The content control component 110 could automatically launch a web page or an application which auto-fills a gift card code, etc.

Similarly, a multimedia content card system 200 can be configured as a coupon, promotion, or advertisement, etc., thereby giving the multimedia content card system 200 monetary value, for example. This means that a recipient, consumer, or user could redeem the multimedia content card system 200 for a discount or other promotion. In one or more embodiments, the content control component 110 or display component 102 can be configured to render a promotion code. The content control component 110 may be configured to manage such promotions or coupons such that these coupons, promotions, offers, etc. expire.

In one or more embodiments, multimedia content card system 200 can be used as a product or service promotion, and the memory component 240 can house multimedia content or content associated with product details, pricing, product specifications, etc. In other embodiments, dating profile information can be stored on memory component 240.

Upon connecting a device, the content control component 110 can be configured to provide a location of an individual or activity of the individual, such as by polling or searching a social networking site, where the individual has ‘checked in’, for example.

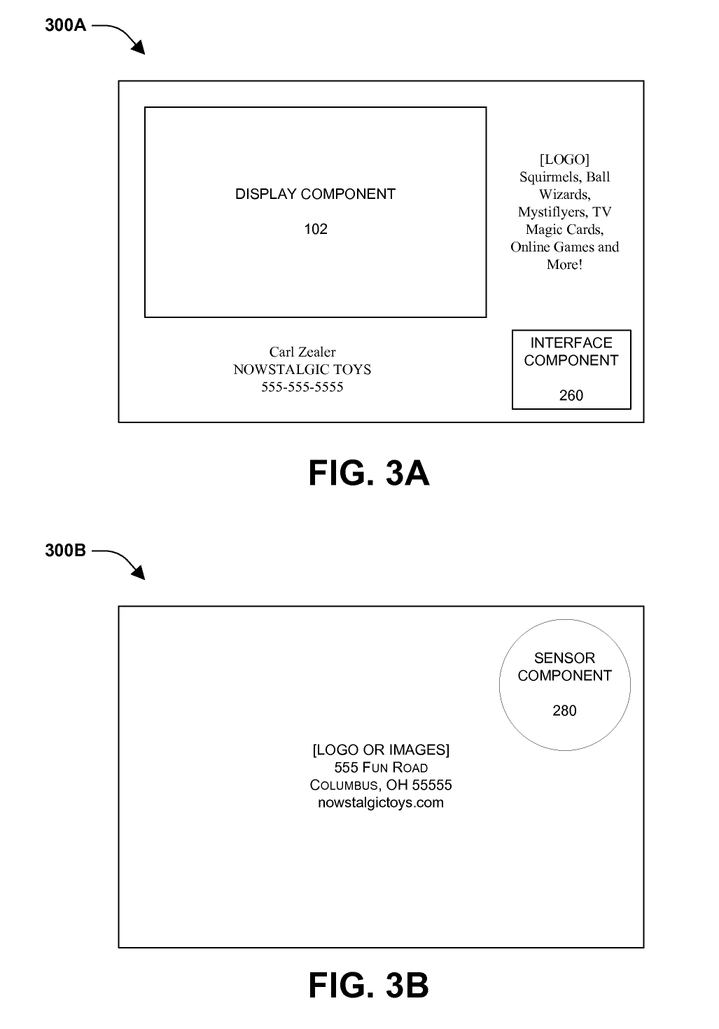

FIG. 3A is an illustration of an example multimedia content card system 300A, according to one or more embodiments. FIG. 3A illustrates a front design of a multimedia content card 300A in accordance with a multimedia business card analogy or embodiment. The multimedia content card 300A can have a display component 102 and an interface component 260. The interface component 260 can be a button, sensor, or other interface device. For example, the interface component 260 can be configured to turn the display component 102 on or off. As another example, the interface component 260 can be configured to cycle the multimedia content card 300A through one or more display modes, where a display mode may present a predetermined set of information to a user. In one or more embodiments, the multimedia content card 300A can have a name, business name, phone number, email, logo, or other identifying information. Such identifying information may be printed, etched, or otherwise attached or embedded on the multimedia content card 300A. In one or more embodiments, the multimedia content card 300A can feature an aesthetic or functional design around or superimposed on display component 102 or the interface component 260. An aesthetic design or functional design can include art, text, logos, trademarks, etc. associated or related to a business (e.g., such as a business issuing or distributing the multimedia business card), person, product, event, trivia, etc.

FIG. 3B is an illustration of an example multimedia content card system 300B, according to one or more embodiments. FIG. 3B illustrates a back design of a multimedia content card 300B in accordance with a multimedia business card analogy. In one or more embodiments, the multimedia content card 300B of FIG. 3B can be the back of the multimedia content card 300A of FIG. 3A. The multimedia content card 300B of FIG. 3B can have a sensor component 280. In one or more embodiments, the sensor component 280 can be on the back of the multimedia content card 300B. In other embodiments, the sensor component 280 can be on the front (not shown) of the multimedia content card 300A. The back of the multimedia content card 300B can have an aesthetic design or a functional design, similar or different from that of the multimedia content card 300A in FIG. 3A.

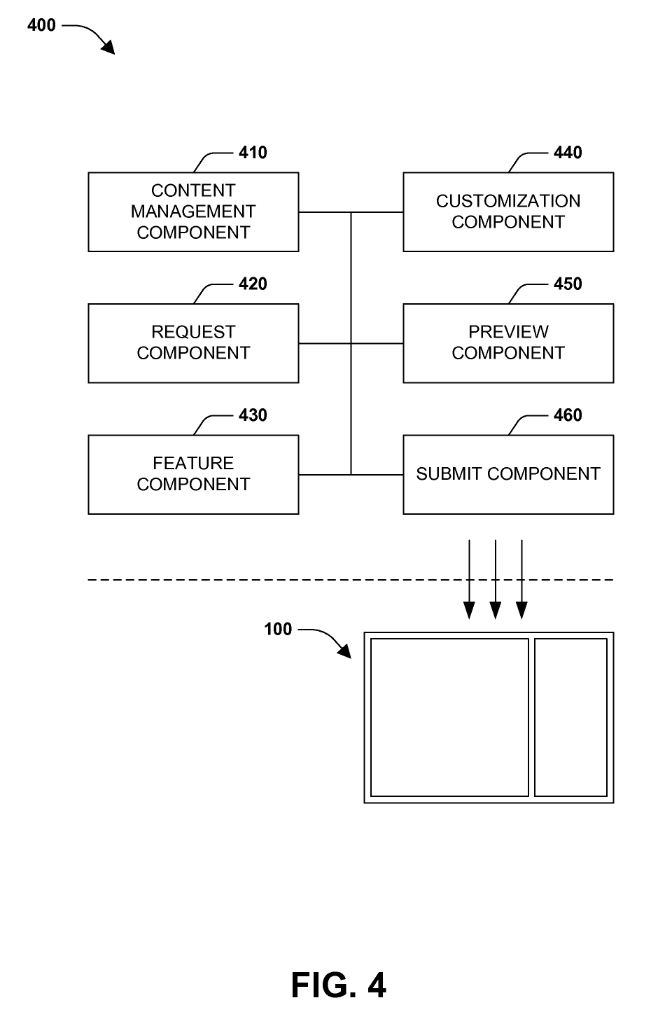

FIG. 4 is an illustration of an example multimedia content card design system 400, according to one or more embodiments. The multimedia content card design system 400 of FIG. 4 can include a content management component 410, a request component 420, a feature component 430, a customization component 440, a preview component 450, and a submit component 460. In one or more embodiments, the multimedia content card design system 400 can be configured to design one or more multimedia content cards, such as the multimedia content card 100 of FIG. 1 (e.g., as indicated below the dashed or dotted line). The multimedia content card design system 400 enables a streamlined or automated approach to provide content or multimedia content for a multimedia content card. In one or more embodiments, the multimedia content card design system 400 can be located on external physical media, loaded on a drive, such as a local device drive, or delivered as a service (e.g., a cloud service, web service, etc.). The multimedia content card design system 400 can be implemented with a wide range of compatibility. For example, the system 400 can be configured to detect a platform associated with a design of a multimedia content card and adjust performance or functionality accordingly. This means that the multimedia content card design system 400 can be implemented in a fashion that enables compatibility on a variety of operating systems or environments. The multimedia content card design system 400 can be configured to detect an environment in which a designer or user loads the multimedia content card design system 400.

The request component 420 can be configured to receive one or more requests for a multimedia content card design. The request component 420 can be configured to load, activate, or receive one or more portions of one or more multimedia content card designs from a content card design library (not shown). The request component 420 can be configured to superimpose one or more portions of one or more multimedia content card designs on one or more portions of one or more other multimedia content card designs. Additionally, the request component 420 can load or activate previously usable design functions on a current screen or load a new screen with one or more design dialogs.

The content management component 410 can be configured to manage content associated with or to be included with or on a multimedia content card. In one or more embodiments, the content management component 410 can be a tool that enables content submission or a tool for managing content layout. For example, the content management component 410 can be configured to select or upload one or more portions of content from a content card design library, a content library, a content card design, an external device, one or more devices, the internet, one or more other sources, etc. to a multimedia content card design. In one or more embodiments, the content management component 410 can be configured to enable a designer or user to arrange a layout or an arrangement of content within a multimedia content card design, which may be used to fabricate, generate, or produce one or more corresponding multimedia content cards.

The content management component 410 can enable a designer or user to configure or select one or more aspects of a multimedia content card (e.g., screen size, amount of storage, peripherals, components, attributes, etc.). In other words, the content management component 410 can be configured to design one or more functional features or one or more aesthetic features for a multimedia content card. Additionally, the content management component 410 can enable the designer to place or layout one or more of the aspects in accordance with one or more design rules. This means the content management component 410 can be configured to organize a physical layout of a multimedia content card design. In one or more embodiments, the content management component 410 can be configured to suggest content for a multimedia content card design, layouts, or other attributes for the multimedia content card design.

Further, the content management component 410 can be configured to enable a designer to place one or more aesthetic designs or logos within the multimedia content card design, thereby utilizing “real estate” within a multimedia content card. In this way, a user or designer can design a multimedia content card to have a similar function or appearance as a traditional business card (e.g., having a company logo, contact information, etc. printed on, attached to, embedded in, etched, etc. around one or more aspects of the multimedia content card, such as a display component 102). In this way, the content management component 410 can be configured to handle or manage one or more portions of content associated with a multimedia content card. For example, some of the content may be physically placed, engraved, embedded, etc. on a multimedia content card. As another example, some of the content can be stored on the multimedia content card.

It will be appreciated that while the multimedia content card may be utilized as a business card in one or more embodiments, other embodiments or applications associated with other multimedia content are contemplated. The content management component 410 can be configured to receive a file from an external device or one or more devices, and import one or more features or attributes from the file to a multimedia content card design. In other embodiments, the content management component 410 can be configured to convert a file to a multimedia content card design or vice versa. In this way, the content management component 410 can be configured to save one or more multimedia content card designs. The content management component 410 can be configured to save one or more of these multimedia content card designs to a multimedia content card design library or a library, thereby enabling one or more multimedia content card designs or one or more portions of such designs to be reloaded, duplicated, updated, etc., for example.

In one or more embodiments, the feature component 430 can be configured to suggest one or more features for inclusion with the multimedia content card design. For example, a feature can include one or more applications, components, utilities, sensors, peripherals, power sources, materials, or other aspects. The feature component 430 can be implemented to provide a list of features, such as a checklist, for example. Additionally, one or more features may be associated with one or more sub-features. For example, a size of a display component 102, an amount of storage, etc. As another example, a camera feature may have sub-features related to a resolution of the camera, a flash, additional storage, transferability of photos, metadata, watermarks to be superimposed on images, etc.

The customization component 440 can be configured to customize one or more multimedia content cards in a particular fashion. For example, a designer or user may desire an order of 500 multimedia content cards. That is, if the user plans on distributing 50 of the multimedia content cards to a first client, one or more of the 50 to be distributed to the first client can be customized to have a personalized greeting. The customization component 440 can be configured to create one or more groups or subsets of multimedia content cards. One or more of these groups or subsets can be configured differently, such as with custom greeting, individualized content, themes, etc. In one or more embodiments, the customization component 440 can be the same as, combined with, or included with the content management component 410.

The preview component 450 can be configured to present a designer or user with one or more views of one or more of the multimedia content card designs. The preview component 450 can be a tool with one or more functions that facilitate review or preview of a multimedia content card design, such as zoom, rotate, scale, ruler, layer selection, cross-sectional views. In other words, the preview component 450 may enable a designer to have a “print preview” of a multimedia content card prior to fabrication. The preview component 450 can include one or more aspects relating to “print preview” functionality (e.g., in two, three, or more dimensions) and “order confirmation” functionality (e.g., view summaries or totals relating to a production run of a product or service).

In addition to one or more of these static features, preview component 450 can simulate use of a designed multimedia content card, allowing a user to interact with interfaces, test sensors, and view or hear one or more portions of multimedia content as would be presented on a completed or fabricated multimedia content card. The preview component 450 may enable the designer to interact with one or more features or functions of the multimedia content card, such as a button or interface component 260, for example. That is, the designer may be able to click on an image or representation of a button or interface component 260 and the preview component 450 can generate a corresponding response (e.g., a virtual response).

Submit component 460 can be configured to accept a submission for a multimedia content card design for production. That is, for example, the submit component 460 can include one or more functions for providing or processing contact information, shipping information, billing information (e.g., credit card processing or third-party payment systems), contracting acceptance of terms, and so forth. In one or more embodiments, the submit component 460 can be configured to generate confirmation information, submit orders, direct contact (e.g., via phone, e-mail, text, other networks, etc. to one or more entities, such as a designer, purchaser, payment handler, manufacturer, etc.), or perform other functions associated with order processing.

In one or more embodiments, the submit component 460 can be configured to submit an order to a manufacturing plant or place the order in a queue for production. In this way, such an order may be processed with no additional human interaction, providing fully-automated production and delivery once a design or a multimedia content card design is submitted. In one or more embodiments, the multimedia content card design system 400 of FIG. 4 can be used to fabricate, order, generate, purchase, or place one or more multimedia content cards 100 in production.

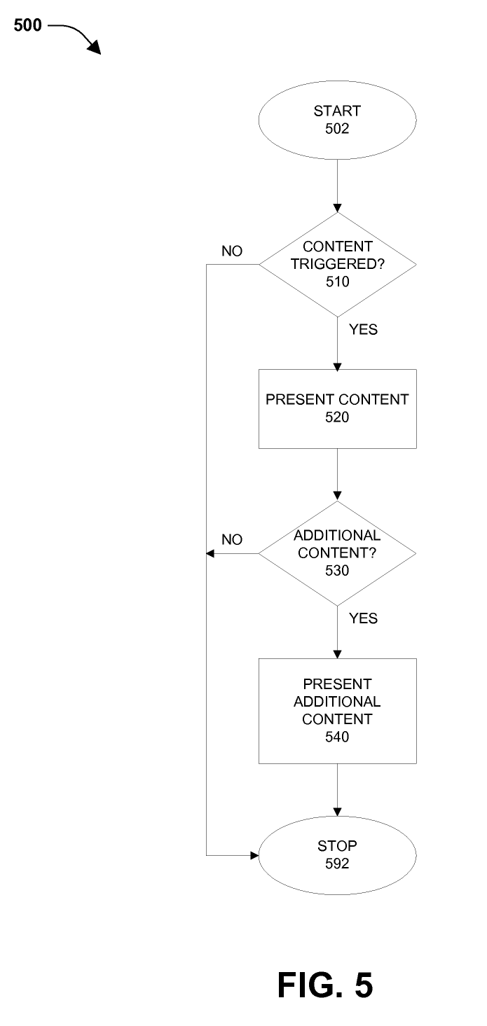

FIG. 5 is an illustration of an example flow diagram of a method 500 for presenting multimedia content, according to one or more embodiments. At 502, the method 500 begins. At 510, a determination can be made regarding whether content is triggered. For example, if content is triggered, corresponding content can be presented at 520. If additional content is available 530 or desired to be displayed or presented, one or more portions of the additional content may be presented at 540. In one or more embodiments, one or more acts may be cycled or repeated. For example, the method 500 may include displaying newly selected content or repeatedly present the same content. In one or more embodiments, the method 500 may include searching for or presented additional content. At 592, the method 500 ends.

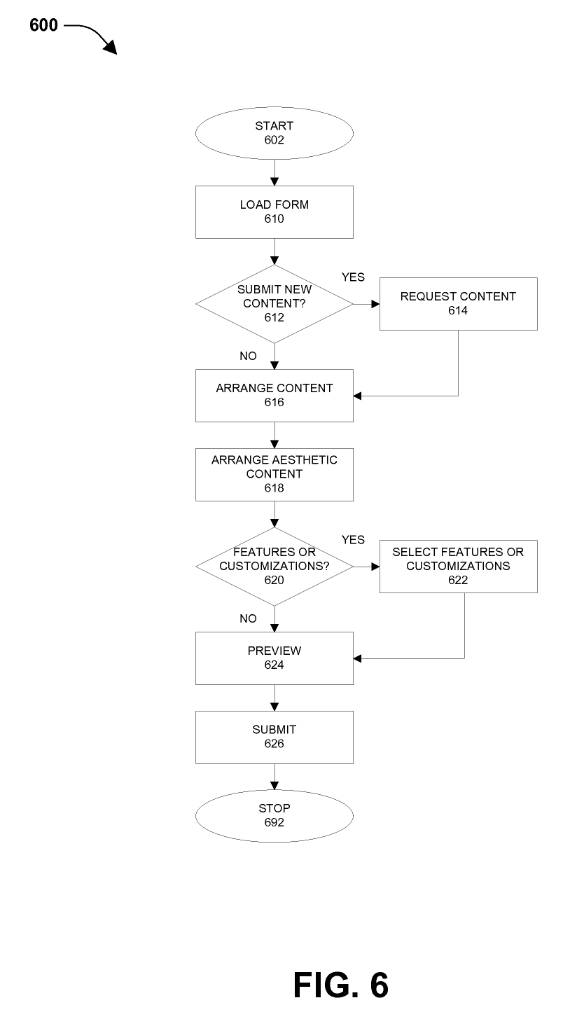

FIG. 6 is an illustration of an example flow diagram of a method 600 for presenting multimedia content, according to one or more embodiments. At 602, the method 600 begins. At 610, the method 600 proceeds to load a form having one or more design options for a multimedia content card. At 612, a determination is made as to whether or not to submit additional content or new content to the multimedia content card. If additional content is desired, the additional content may be requested or processed at 614. At 616, one or more portions of the content or multimedia content can be arranged. The content can be stored on a memory of the multimedia content card or retrieved from one or more devices via a communication port, for example. In other words, content can include one or more portions of content stores on the multimedia content card or accessed from other locations (e.g., a mobile device, a computer, a flash drive, etc.). In one or more embodiments, content may be accessed from one or more connected devices (e.g., via a communication component 230 or communication port). Additionally, one or more conditions associated with one or more portions of content can be determined as well.

At 618, aesthetic content can be arranged on the multimedia content card. For example, aesthetic content may include formatting, positioning, sizing, color, font, images, overlays, superimpositions, etc. At 620, features or customizations may be included based on a determination (e.g., from a designer of the multimedia content card). For example, one or more features or one or more customizations may be selected, added, included, etc. at 622. At 624, a preview can be generated for the multimedia content card. The preview can include one or more views, such as a front view, a back view, a top-down view, one or more views corresponding to one or more modes of the multimedia content card, etc. At 626 a multimedia content card design may be submitted. Submission 626 may include ordering, payment, payment processing, manufacturing, etc. of one or more multimedia content cards. At 692, the method 600 may be concluded. In one or more embodiments, other algorithms, techniques, alternative ordering of acts, additional or different functionality, etc. may be implemented.

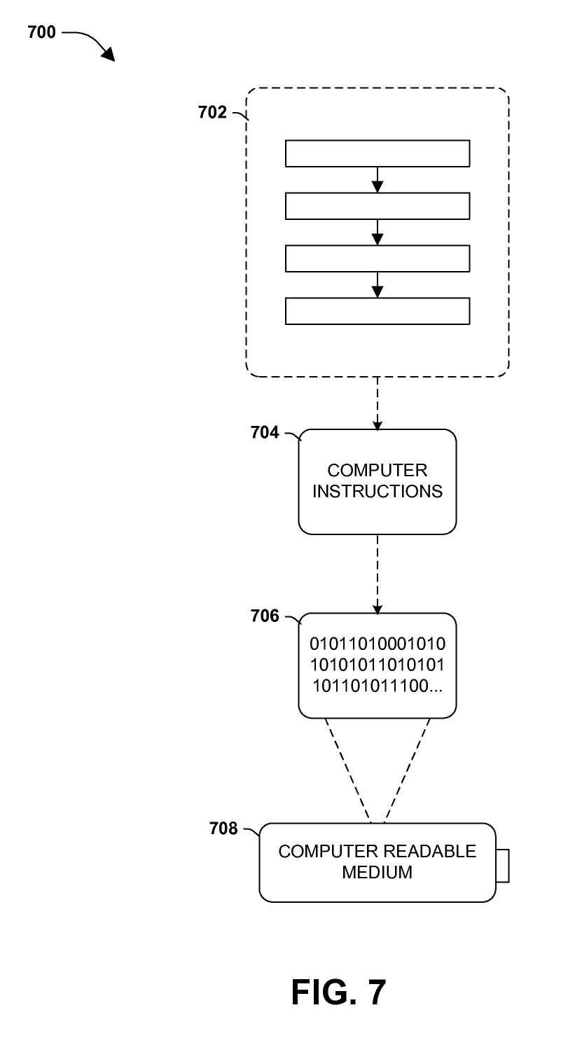

Still another embodiment involves a computer-readable medium including processor-executable instructions configured to implement one or more embodiments of the techniques presented herein. An embodiment of a computer-readable medium or a computer-readable device that is devised in these ways is illustrated in FIG. 7, wherein an implementation 700 includes a computer-readable medium 708, such as a CD-R, DVD-R, flash drive, a platter of a hard disk drive, etc., on which is encoded computer-readable data 706. This computer-readable data 706, such as binary data including a plurality of zero's and one's as shown in 706, in turn includes a set of computer instructions 704 configured to operate according to one or more of the principles set forth herein. In one such embodiment 700, the processor-executable computer instructions 704 are configured to perform a method 702, such as the method 100 of FIG. 1 or the method 400 of FIG. 4. In another embodiment, the processor-executable instructions 704 are configured to implement a system, such as the system 600 of FIG. 6. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 8 and the following discussion provide a description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions are implemented as program modules, such as functions, objects, Application Programming Interfaces (APIs), data structures, and the like, that perform particular tasks or implement particular abstract data types. Typically, the functionality of the computer readable instructions are combined or distributed as desired in various environments.

FIG. 8 illustrates a system 800 including a computing device 812 configured to implement one or more embodiments provided herein. In one configuration, computing device 812 includes at least one processing unit 816 and memory 818. Depending on the exact configuration and type of computing device, memory 818 may be volatile, such as RAM, non-volatile, such as ROM, flash memory, etc., or a combination of the two. This configuration is illustrated in FIG. 8 by dashed line 814.

In other embodiments, device 812 includes additional features or functionality. For example, device 812 also includes additional storage such as removable storage or non-removable storage, including, but not limited to, magnetic storage, optical storage, and the like. Such additional storage is illustrated in FIG. 8 by storage 820. In one or more embodiments, computer readable instructions to implement one or more embodiments provided herein are in storage 820. Storage 820 also stores other computer readable instructions to implement an operating system, an application program, and the like. Computer readable instructions are loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media is part of device 812.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 812 includes input device(s) 824 such as keyboard, mouse, pen, voice input device, touch input device, infrared cameras, video input devices, or any other input device. Output device(s) 822 such as one or more displays, speakers, printers, or any other output device are also included in device 812. Input device(s) 824 and output device(s) 822 are connected to device 812 via a wired connection, wireless connection, or any combination thereof. In one or more embodiments, an input device or an output device from another computing device are used as input device(s) 824 or output device(s) 822 for computing device 812. Device 812 also includes communication connection(s) 826 to facilitate communications with one or more other devices. Additionally, where video or video streams are described, it will be appreciated that video, audio, or combinations thereof can be employed according to one or more aspects.

According to one or more aspects, a system for providing multimedia is provided, including a display component embedded within a card housing, the display component formed of a flexible material, a memory component configured to store one or more portions of content, and a content control component configured to access one or more portions of the content and cause the display component to render one or more of the portions of content.

The system can include a communication component configured to enable connectivity between the system and one or more devices, a power component configured to provide power to the display component, the memory component, or the content control component, or an interface component configured to accept one or more inputs. The content control component can be configured to cause the display component to render one or more other portions of content based on one or more of the inputs, launch one or more portions of the content in response to a connection to one or more devices, detect one or more applications on one or more devices in response to a connection to one or more of the devices, or compose an email based on detecting one or more email application on one or more of the devices. The email can be addressed to an email address stored on the memory component or addressed to an email address determined based on content stored on the memory component.

The system can include an audio component configured to provide audio playback of one or more portions of the content, a sensor component configured to detect one or more inputs, or one or more additional display components, such as a second display component, a third display component, etc. In one or more embodiments, one or more portions of the content can comprise text, images, animations, video, data streams, audio, reactive content, or interactive content.

According to one or more aspects, a method for providing multimedia content is provided, including storing one or more portions of content, rendering one or more portions of the content on a flexible display, and launching one or more applications on one or more devices based on a connection to one or more of the devices and one or more portions of the content. One or more of the applications can be a phone application, an email application, a social media application, etc. One or more of the devices can be a tablet, a mobile device, a phone, a computer, etc.

According to one or more aspects, a computer-readable storage medium comprising computer-executable instructions, which when executed via a processing unit on a computer performs acts. One or more of these acts can include storing one or more portions of content, wherein one or more portions of the content is associated with social media of a first entity, rendering one or more portions of the content on a flexible display, launching one or more applications on one or more devices based on a connection to one or more of the devices and one or more portions of the content, where in one or more of the applications is a social media application, and initiating a social media friend request from a second entity to the first entity.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Also, although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system for providing multimedia content, comprising:
a display component embedded within a card housing, the display component formed of a flexible material;
a memory component configured to store one or more portions of content; and
a content control component configured to:
access one or more portions of the content; and
cause the display component to render one or more of the portions of content.

2. The system of claim 1, comprising a communication component configured to enable connectivity between the system and one or more devices.

3. The system of claim 1, comprising a power component configured to provide power to the display component, the memory component, or the content control component.

4. The system of claim 1, comprising an interface component configured to accept one or more inputs.

5. The system of claim 4, the content control component configured to cause the display component to render one or more other portions of content based on one or more of the inputs.

6. The system of claim 1, the content control component configured to launch one or more portions of the content in response to a connection to one or more devices.

7. The system of claim 1, the content control component configured to detect one or more applications on one or more devices in response to a connection to one or more of the devices.

8. The system of claim 7, the content control component configured to compose an email based on detecting one or more email application on one or more of the devices.

9. The system of claim 8, wherein the email is addressed to an email address stored on the memory component.

10. The system of claim 8, wherein the email is addressed to an email address determined based on content stored on the memory component.

11. The system of claim 1, comprising an audio component configured to provide audio playback of one or more portions of the content.

12. The system of claim 1, comprising a sensor component configured to detect one or more inputs.

13. The system of claim 1, comprising a second display component.

14. The system of claim 1, wherein one or more portions of the content comprise text, images, animations, video, data streams, audio, reactive content, or interactive content.

15. A method for providing multimedia content, comprising:
storing one or more portions of content;
rendering one or more portions of the content on a flexible display; and
launching one or more applications on one or more devices based on a connection to one or more of the devices and one or more portions of the content.

16. The method of claim 11, wherein one or more of the applications is a phone application.

17. The method of claim 11, wherein one or more of the devices is a tablet, mobile device, or computer.

18. A computer-readable storage medium comprising computer-executable instructions, which when executed via a processing unit on a computer performs acts, comprising:
storing one or more portions of content, wherein one or more portions of the content is associated with social media of a first entity;
rendering one or more portions of the content on a flexible display;
launching one or more applications on one or more devices based on a connection to one or more of the devices and one or more portions of the content, where in one or more of the applications is a social media application; and
initiating a social media friend request from a second entity to the first entity.

19. The computer-readable storage medium of claim 18, wherein one or more of the applications is a phone application.

20. The computer-readable storage medium of claim 18, wherein one or more of the devices is a tablet, mobile device, or computer.
